(19) United States
(12) Patent Application Publication
(10) Pub. No.: US 2019/0183740 A1
(43) Pub. Date: Jun. 20, 2019

(54) METHOD FOR STIRRING MILK POWDER SOLUTION AND STIRRING TYPE FEEDING-BOTTLE

(71) Applicant: GUANGZHOU MATHER BELLE MATERNITY-INFANT PRODUCT CO ., LTD, Huada, Guangzhou, Guangdong (CN)

(72) Inventor: Tingyun YANG, Huadu (CN)

(73) Assignee: Guangzhou Mather Belle Maternity-Infant Product Co., Ltd, Huada, Guangzhou, Guangdong (CN)

(21) Appl. No.: 16/310,770

(22) PCT Filed: Mar. 22, 2017
(86) PCT No.: PCT/CN2017/077658

§ 371 Date: Dec. 17, 2018

(30) Foreign Application Priority Data
Jun. 17, 2016 (CN) 201610432880.9
Jun. 17, 2016 (CN) 201620593691.5

(51) Int. Cl. A61J 9/00; B01F 13/08; B01F 1/00

(52) U.S. Cl. CPC A61J 9/006; B01F 2215/0014; B01F 1/0011; B01F 13/089

(57) ABSTRACT

Disclosed are a method for stirring milk powder solution and a stirring type feeding-bottle. The method comprising: driving a counterweight head (24) and a flexible straw (23) to revolve by a drive device (12). The stirring type feeding-bottle includes a feeding-bottle assembly (2) comprising a feeding-bottle (21), a nipple subassembly (22), a flexible straw (23) and a counterweight head (24). The counterweight head (24) is connected to a lower end of the flexible straw (23). The stirring type feeding-bottle further comprises a drive device (12) for driving the flexible straw (23) and the counterweight head (24) to revolve. A gap is formed between the counterweight head (24) and an inner bottom surface of the feeding-bottle (21). The stirring type feeding-bottle achieves automatic stirring, reduces the generation of bubbles in the stirring process, and improves the uniformity of stirring and facilitates feeding.

### CROSS REFERENCE TO RELATED APPLICATIONS

This application is a continuation of International Application No. PCT/CN2017/077658, filed on Mar. 22, 2017, which is based upon and claims priority to Chinese Patent Application No. CN20161432880.9, filed on Jun. 17, 2016, and Chinese Patent Application No. CN20162593691.5, filed on Jun. 17, 2016, the entire contents of each of which are incorporated herein by reference.

### TECHNICAL FIELD

The present invention relates to the field of feeding-bottles, and in particular to feeding-bottles which are stirred by magnetic actuation.

### BACKGROUND

A feeding-bottle is an appliance used to hold milk powder solution, and is generally used for babies. The feeding-bottle itself does not contain a nipple, and merely refers to the bottle. However, usually the manufacturer who produces the baby feeding-bottle will give a nipple with the feeding-bottle. Feeding-bottles generally include glass feeding-bottles, plastic feeding-bottles and silicone feeding-bottles.

When feeding a baby with a feeding-bottle, milk powder and water should be mixed evenly. To achieve a more uniform mixing of the milk powder and the water, the feeding-bottle needs to be shaken, but if the bottle is shaken irregularly, the dissolved milk powder solution is easy to bubble and will not be mixed uniformly enough. If the baby drinks the milk powder solution with bubbles, the baby is prone to burping and spitting up a little milk, which has a certain impact on the baby's health. Of course, people now often dissolve and homogenize the milk powder solution in a way that moves the feeding-bottle back and forth. Compared to the conventional method, there is improvement in the generation of bubbles. However, since it is difficult to control the shaking speed of the feeding-bottle, bubbles still exist, and homogenization level is not high. If the milk powder is not fully dissolved, the baby will not digest after drinking.

Currently, a feeding-bottle assembly in which a stirring device is provided in a feeding-bottle has been proposed. For example, an electric feeding-bottle is disclosed in Chinese Utility Model Application No. 200520083289.4, issued on Aug. 2, 2006, and specifically discloses a miniature electric stirrer in the feeding-bottle. When in use, firstly, the nipple is taken down, milk powder and water are put into the feeding-bottle, the specially designed micro electric stirrer is then installed in the feeding-bottle. When the switch is turned on, the micro electric stirrer starts to work, after stirring evenly, the stirrer is taken out and rinsed, and then the nipple can be placed on the feeding-bottle. According to the structure, during the stirring process of the stirrer, a water channel is formed behind the stirrer, and air may enter the milk powder solution through the water channel. When the milk powder solution shuts, the air is wrapped therein. The air will float upwards because it is lighter than water, thus bubbles will be generated. Therefore, the milk powder solution that is evenly stirred will still generate bubbles. The baby is prone to burping, spitting up a little milk, and bloating.

A multifunctional feeding-bottle device including a feeding-bottle, a stirring device, a driving device, a heating device, a circuit control device, a vacuum device and a base is disclosed in Chinese Utility Model Application No. 201320852410, the vacuum device comprising a vacuum housing, the driving device, the heating device and the circuit control device being located in the base, the driving device, the heating device and the circuit control device being electrically connected, a concave position where the feeding bottle can be embedded being formed in the base, a closed space being formed between the vacuum housing and the concave position, the feeding-bottle being located in the closed space formed between the vacuum housing and the concave position, and the stirring device being positioned within the feeding-bottle. Although the structure has a multifunctional feeding-bottle device that can stir the milk powder, heat the milk powder solution and keep it warm and fresh, and can also clean, sterilize and disinfect the feeding-bottle, during the stirring process, a water channel is formed behind the stirring device, and the air enters the milk powder solution through the water channel. When the milk powder solution shuts, the air is wrapped therein. The air will float upwards because it is lighter than water, thus bubbles will be generated. Therefore, the milk powder solution that is evenly stirred will still generate bubbles. Baby is prone to burping, spitting up a little milk, and bloating. Further, the driven magnet of the stirring device is exposed to the outside, and is directly in contact with the milk powder solution during the stirring process, so that the milk powder solution is easily contaminated.

### SUMMARY

In order to achieve automatic stirring, reduce the generation of bubbles during stirring, improve the uniformity of stirring, and facilitate feeding, the present invention provides a method for stirring milk powder solution and a stirring type feeding-bottle.

To achieve the above object, an embodiment of the present invention provides a stirring type feeding-bottle including a base and a feeding-bottle assembly, the base comprising a base body and a magnetic drive device disposed in the base body, a top surface of the base body having a feeding-bottle placement position; the feeding-bottle assembly including a feeding-bottle, a nipple subassembly, a flexible straw and a counterweight head, the nipple subassembly being disposed on the feeding-bottle, an upper end of the flexible straw being connected to the nipple subassembly, and the counterweight head being connected to a lower end of the flexible straw; the counterweight head being a magnetic bead assembly; the magnetic drive driving the flexible straw and the bead assembly to rotate; and a gap being formed between the bead assembly and an inner bottom surface of the feeding-bottle.

In another embodiment of the present application, a method for stirring milk powder solution is provided, comprising: driving a counterweight head and a flexible straw to revolve by a drive device, wherein the flexible straw and the counterweight head are driven to rotate on their own axis in an opposite direction to the revolution of the counterweight head and the flexible straw, and wherein the milk powder solution revolves with the revolution of the counterweight head and the flexible straw, causing the revolving milk powder solution surface to be low in the middle and high in the periphery to form a vortex, the milk powder solution at the bottom of the feeding-bottle flowing outward from the middle because a centripetal force of the milk powder solution near the side of the weight head is large, when the milk powder solution flows outward, the milk powder solution in the outer layer moving outward, thus the milk powder solution in the upper layer being replenished from the outer layer to the middle to make the milk powder solution flow towards the middle from the outer side in the upper layer, and the milk powder solution flow from up to down in the middle, so that the milk powder solution moves from up to down in the middle and moves from down to up in the outer layer in the axial direction, during the rotation of the milk powder solution, the milk powder in the milk powder solution forming a cycle with spiral ascending followed by spiral descending.

According to structure and method as mentioned above, when the drive device is in operation, the drive device drives the counterweight head and the flexible straw to revolve, thereby serving as stirring. In the present invention, the flexible straw is connected to the nipple, and the portion of the flexible straw connected to the nipple does not rotate with respect to the nipple, so that when the counterweight head and the flexible straw are driven by the drive device to revolve, the flexible straw and the counterweight head rotate on their own axis in an opposite direction to the revolution of the counterweight head and the flexible straw. Therefore, when the counterweight head and the flexible straw revolve, even if a water channel is formed behind the counterweight head and the flexible straw, the milk powder solution will fill the water channel rapidly due to the rotation, making it difficult for air to enter the water channel. Thus, when milk powder solution is stirred by means of the structure of the present invention, the milk powder solution will generate fewer or even no bubbles, and even if a small amount of bubbles are generated, they will disappear within a short time.

The milk powder solution will revolve as the flexible straw and the counterweight head revolve, especially when the flexible straw revolves, causing the rotating milk powder solution surface to be low in the middle and high in the periphery to form a vortex. Since the lower end of the flexible straw is connected to the counterweight head, when the flexible straw and the counterweight head revolve simultaneously, a centripetal force of the milk powder solution near the side of the counterweight head is large, which makes it possible that the milk powder solution at the bottom of the feeding-bottle flows outward from the middle; when the milk powder solution flows outward, the milk powder solution in the outer layer moves outward, and the milk powder solution in the upper layer is replenished from the outer layer to the middle, so that the milk powder solution flows towards the middle from the outer side in the upper layer ; and the middle milk powder solution flows from up to down, thereby the milk powder solution moves from up to down in the middle and moves from down to up in the outer layer in the axial direction. At the same time, during the rotation of the milk powder solution, the milk powder in the milk powder solution forms a cycle with spiral ascending followed by spiral descending, so that the mixing of the milk powder solution is more uniform.

In the present invention, the flexible straw and the counterweight head serve to stir and at the same time serve as a straw for feeding, thereby facilitating feeding.

The magnetic actuation solves the sealing problem that is difficult to address with dynamic seal.

Further, the magnetic drive device comprises a motor, a holder and a magnet, the holder is mounted on an output shaft of the motor, and two or more magnets are arranged on the holder outside an axis of output shaft of the motor. In this configuration, since the magnet is provided outside the output shaft of the motor output shaft, the driving force applied to the magnetic bead assembly is large and balanced.

Further, the base body includes a lower casing and an upper casing, and the upper casing is snapped on the lower casing; and an upward protrusion is disposed at a central portion of the lower casing, the protrusion has a holding cavity therein, and the motor is disposed in the holding cavity. Since the base body is provided with a lower casing and an upper casing, it is convenient to install and remove the magnetic drive device. Since the holding cavity is provided, it has a positioning function for the motor and achieves high reliability for motor's mounting.

Further, a concave recessed portion is disposed on a top surface of the upper casing, a pad is disposed in the recessed portion, and an upper surface of the pad acts as the feeding-bottle placement position. When the feeding-bottle assembly is frequently taken and put, there is wear between the feeding-bottle and the pad. With the above structure, when the pad is worn, it is convenient to replace the pad separately, and the cost is low.

Further, the holder includes a connecting post and a supporting portion extending outward from a central portion of the connecting post, and the support portion is provided with a bearing portion that is symmetrical with respect to the connecting post. The bearing portion is provided with a magnet cavity therein, and the magnet is disposed in the magnet cavity. By providing the magnet cavity, the magnet can be fixed, and no additional fixing means is required, which simplifies the structure. Moreover, the magnets are symmetrically arranged to make the magnetic driving force uniform.

Further, the magnetic bead assembly includes a magnetic bead, a hardened layer wrapped around the magnetic bead, and silicone body wrapped around the hardened layer. Silicone body is a safe and environment-friendly material for the human body. The magnetic beads are wrapped in the silicone body. When the magnetic bead assembly is in contact with the milk powder solution, the milk powder solution is not easily contaminated, which is safer, healthier and more environmentally friendly. At the same time, the hardened layer can protect the magnetic beads more reliably.

### BRIEF DESCRIPTION OF THE DRAWINGS

FIG. 1 is a schematic view of the structure according to an embodiment of the present invention.

FIG. 2 is a schematic view of the milk powder solution according to an embodiment of the present invention as it revolves.

### DETAILED DESCRIPTION

The present invention will be further described in detail below in conjunction with the drawings and specific embodiments.

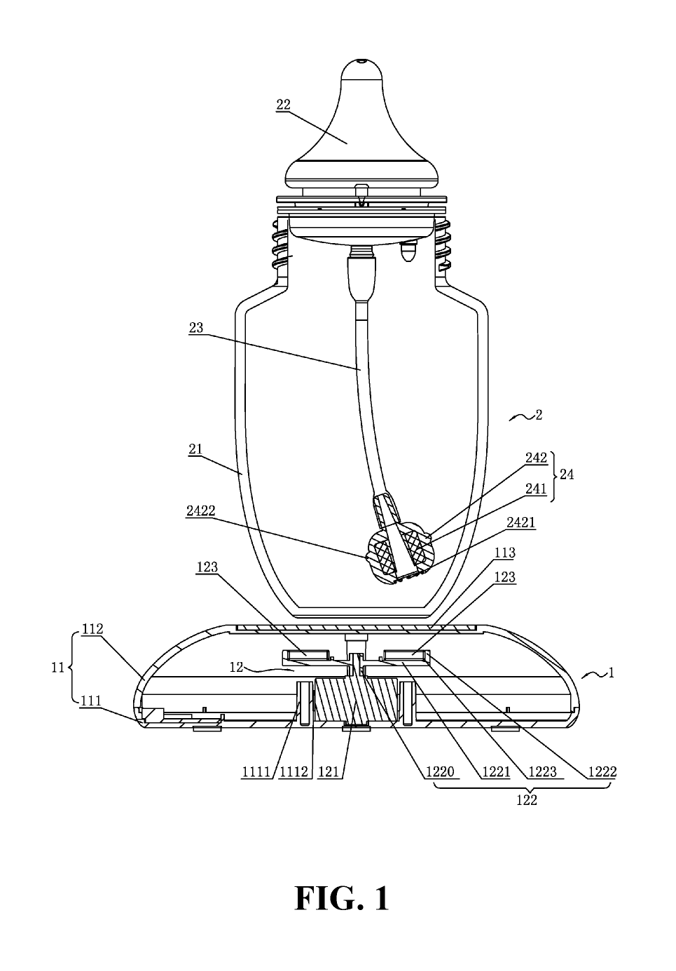

As shown in FIG. 1, the stirring type feeding-bottle includes a base 1 and a feeding-bottle assembly 2.

The base 1 includes a base body 11 and a drive device disposed in the base body 11. In the embodiment, the drive device may be a magnetic drive device 12.

The base body 11 includes a lower casing 111 and an upper casing 112. The upper casing 112 is snapped on the lower casing 111, so that the magnetic drive device 12 is conveniently installed and disassembled. The lower casing 111 is provided with an upward protrusion 1111 at a central position. The protrusion 1111 has a holding cavity 1112 for holding a motor. A concave recessed portion is provided on a top surface of the upper casing 112. A pad 113 is disposed in the recessed portion. An upper surface of the pad 113 acts as a feeding-bottle placement position. When the pad 113 is worn, it is convenient to replace the pad 113 separately, and the cost is low.

The magnetic drive device 12 includes a motor 121, a holder 122, and a magnet 123. The motor is held in the holding cavity. The holding cavity has a positioning function on the motor 121, thereby ensuring high mounting reliability of the motor 121.

The holder 122 includes a connecting post 1220 and a supporting portion 1221 extending outward from a central portion of the connecting post 1220. The supporting portion 1221 is provided with a bearing portion 1222 symmetric with respect to the connecting post. A magnet cavity 1223 is disposed within the bearing portion. The magnet 123 is provided inside the magnet cavity 1223. The connecting post 1220 is sleeved on an output shaft of the motor. When the motor is working, the output shaft of the motor 121 drives the holder 122 to revolve, and the holder 122 in turn drives the magnet 123 to revolve. By providing the magnet cavity 1223, the magnet 123 can be fixed without any additional fixing means, which simplifies the structure. Further, the magnet 123 is symmetrically arranged to make the magnetic driving force uniform and large.

The feeding-bottle assembly 2 includes a feeding-bottle 21, a nipple subassembly 22, a flexible straw 23 and a counterweight head. In one embodiment, the counterweight head may be a magnetic bead assembly 24. The nipple subassembly 22 includes a cover and a nipple. The nipple is disposed on the feeding-bottle 21 through the cover. The flexible straw 23 is a silicone straw. An upper end of the flexible straw 23 is inserted into an interface at the bottom of the nipple. The magnetic bead assembly 24 includes a magnetic bead 241, a hardened layer wrapped around the magnetic bead 241, and a silicone body 242 wrapped around the hardened layer (not shown). An upper end of the silicone body 242 is inserted at a lower end of the flexible straw. A through hole is formed in the middle of the silicone body 242 which communicates with the flexible straw 23. A gap is formed between the magnetic bead assembly 24 and an inner bottom surface of the feeding-bottle. Silicone body is a safe and environmentally friendly material for the human body. The magnetic beads 241 are wrapped in the silicone body 242, the milk powder solution is not easily contaminated, and is safer, more hygienic and more friendly to environment, when the magnetic bead assembly is in contact with the milk powder solution. At the same time, the hardened layer can protect the magnetic beads more reliably. A convex rib 2421 is provided at the bottom of the silicone body 242, thus reducing the possibility of blockage of the silicone body. A convex ring 2422 is provided on the outer circumference of the silicone body 242 to improve the uniformity of stirring.

In this embodiment, the milk powder solution is stirred in such a way that the feeding-bottle assembly 2 is placed on the feeding-bottle placement position of the pad, the motor 121 is started, the motor 121 drives the holder 122 to revolve, the holder 122 in turn drives the magnet 123 to revolve, thereby the magnetic bead assembly 24 is driven to revolve under a magnetic field, and the flexible straw is driven to revolve by the magnetic bead assembly 24. In the present invention, the rotation of the counterweight head and the flexible straw refers to revolution. Meanwhile, since the upper end of the flexible straw 23 is inserted into the nipple and they do not revolve relative to each other, the flexible straw 23 and the magnetic bead assembly 24 rotate on their own axis in an opposite direction to the revolution of the magnetic bead assembly 24 and the flexible straw 23. The milk powder solution may revolve as the magnetic bead assembly 24 and the flexible straw 23 revolve, causing the revolving milk powder solution surface to be low in the middle and high in the periphery to form a vortex. A centripetal force of the milk powder solution near the side of the magnetic bead assembly 24 is large, so that the milk powder solution at the bottom of the feeding-bottle flows outward from the middle. When the milk powder solution flows outward, the milk powder solution in the outer layer moves outward, the milk powder solution in the upper layer is replenished from the outer layer to the middle, so that the milk powder solution in the upper layer flows from the outer side to the middle. The middle milk powder solution flows from up to down, so that the milk powder solution moves from up to down in the middle and moves from down to up in the outer layer in the axial direction. At the same time, during the rotation of the milk powder solution, the milk powder in the milk powder solution forms a cycle with spiral ascending followed by spiral descending.

According to such structure of this embodiment, when the magnetic drive device 12 is in operation, the magnetic drive device 12 drives the magnetic bead assembly 24 to revolve, and the magnetic bead assembly 24 in turn drives the flexible straw 23 to revolve, which serves to stir. The flexible straw 23 is connected to the nipple, and the portion of the flexible straw 23 connected to the nipple does not rotate with respect to the nipple. Thus, when the magnetic bead assembly 24 and the flexible straw 23 are driven to revolve by the magnetic drive device 12, the flexible straw 23 and the magnetic bead assembly 24 will rotate on their own axis in an opposite direction to the revolution of the magnetic bead assembly 24 and the flexible straw 23. Therefore, even when the magnetic bead assembly 24 and the flexible straw 24 revolve, even a water channel is generated behind the magnetic bead assembly 24 and the flexible straw 23, the milk powder solution will fill the water channel rapidly due to the rotation, making it difficult for air to enter the water channel. Thus, when milk power solution is stirred by means of the structure of the present invention, the milk powder solution will generate fewer or no bubbles, and even if a small amount of bubbles is generated, they will disappear within a short time.

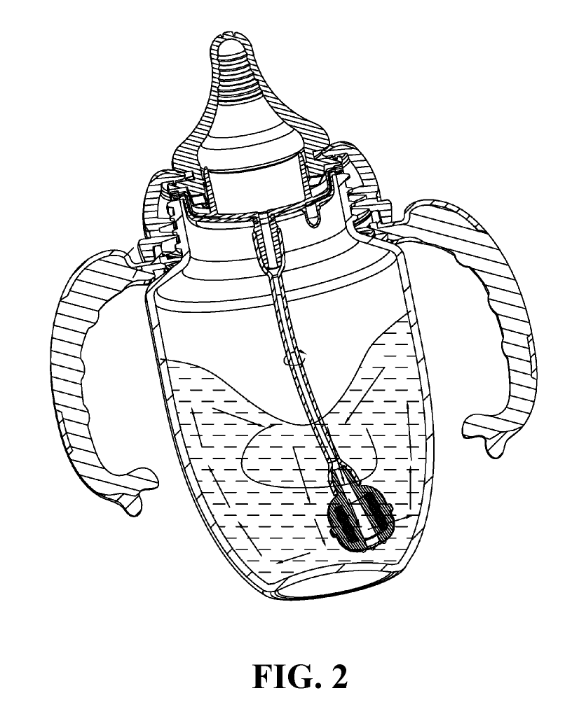

When the flexible straw 23 and the magnetic bead assembly 24 revolve, the milk powder solution will follow the revolution, especially when the flexible straw 23 follows the revolution, causing the rotating milk powder solution surface to be low in the middle and high in the periphery to form a vortex. Since the lower end of the flexible straw 23 is connected to the magnetic bead assembly 24, when the flexible straw 23 and the magnetic bead assembly 24 revolve simultaneously, a centripetal force of the milk powder solution near the side of the magnetic bead assembly 24 is large, as shown in FIG. 2, so that the milk powder solution at the bottom of the feeding-bottle flows outward from the middle. When the liquid flows outward, the milk powder solution in the outer layer moves outward, and the milk powder solution in the upper layer is replenished from the outer layer to the middle, so that the milk powder solution flows from the outer side in the upper layer to the middle. The middle milk powder solution flows from up to down, so that the milk powder solution moves from up to down in the middle and moves from down to up in the outer layer. At the same time, during the rotation of the milk powder solution, the milk powder in the milk powder solution forms a cycle with spiral ascending followed by spiral descending. In this way, the mixing of the milk powder solution is more uniform.

In the present invention, the flexible straw and the magnetic bead assembly 24 serve to stir and at the same time serve as a straw for feeding, thus facilitating feeding.

1. A method for stirring milk powder solution, comprising: driving a counterweight head and a flexible straw to revolve by a drive device,
wherein the flexible straw and the counterweight head are driven to rotate on their own axis in an opposite direction to the revolution of the counterweight head and the flexible straw, and
wherein the milk powder solution revolves with the revolution of the counterweight head and the flexible straw, causing the revolving milk powder solution surface to be low in the middle and high in the periphery to form a vortex, the milk powder solution at the bottom of the feeding-bottle flowing outward from the middle because a centripetal force of the milk powder solution near the side of the weight head is large, when the milk powder solution flows outward, the milk powder solution in the outer layer moving outward, thus the milk powder solution in the upper layer being replenished from the outer layer to the middle to make the milk powder solution flow towards the middle from the outer side in the upper layer, and the milk powder solution flow from up to down in the middle, so that the milk powder solution moves from up to down in the middle and moves from down to up in the outer layer in the axial direction, during the rotation of the milk powder solution, the milk powder in the milk powder solution forming a cycle with spiral ascending followed by spiral descending.

2. The method for stirring milk powder solution according to claim 1, wherein the drive device is a magnetic drive device, the counterweight head is a magnetic bead assembly, the magnetic bead assembly being driven to revolve under a magnetic force when the magnetic drive device is working, and in turn driving the flexible straw to revolve.

3. The method for stirring milk powder solution according to claim 2, wherein the magnetic drive device comprises a motor, a holder and a magnet, the holder being mounted on an output shaft of the motor, and two or more magnets being provided on the holder outside an output shaft of the motor.

4. The method for stirring milk powder solution according to claim 2, wherein the magnetic bead assembly comprises a magnetic bead, a hardened layer wrapped around the magnetic bead, and silicone body wrapped around the hardened layer.

5-10. (canceled)

11. A stirring type feeding-bottle, comprising a feeding-bottle assembly comprising a feeding-bottle, a nipple subassembly, a flexible straw and a counterweight head; the nipple subassembly being disposed on the feeding-bottle, an upper end of the flexible straw being connected to the nipple subassembly, and the counterweight head being connected to a lower end of the flexible straw;
wherein the stirring type feeding-bottle further comprising a drive device for driving the flexible straw and the counterweight head to revolve; and
a gap is formed between the counterweight head and an inner bottom surface of the feeding-bottle.

12. The stirring type feeding-bottle according to claim 11, further comprising a base, the base comprising a base body and a magnetic drive device disposed in the base body, a top surface of the base body having a feeding-bottle placement position; the counterweight head being a magnetic bead assembly; and the drive device being a magnetic drive device.

13. The stirring type feeding-bottle according to claim 12, wherein the magnetic drive device comprises a motor, a holder and a magnet, the holder being mounted on an output shaft of the motor, and two or more magnets being provided on the holder outside an axis of an output shaft of the motor.

14. The stirring type feeding-bottle according to claim 13, wherein the base body comprises a lower casing and an upper casing, the upper casing being snapped on the lower casing; and the lower casing being provided with an upward protrusion at a central position, the protrusion having a holding cavity therein, and the motor being disposed in the holding cavity.

15. The stirring type feeding-bottle according to claim 14, wherein a concave recessed portion is disposed on a top surface of the upper casing, a pad is disposed in the recessed portion, and an upper surface of the pad is the feeding-bottle placement position.

16. The stirring type feeding-bottle according to claim 13, wherein the holder comprises a connecting post and a supporting portion extending outward from a central portion of the connecting post, the supporting portion being provided with a bearing portion symmetric with respect to the connecting post, a magnet cavity being disposed in the bearing portion, and a magnet being disposed in the magnet cavity.

17. The stirring type feeding-bottle according to claim 12, wherein the magnetic bead assembly comprises a magnetic bead, a hardened layer wrapped around the magnetic bead, and silicone body wrapped around the hardened layer.

18. The stirring type feeding-bottle according to claim 17, wherein a convex rib is provided at the bottom of the silicone body.

19. The stirring type feeding-bottle according to claim 11, wherein the flexible straw is a silicone straw.

20. A magnetic bead assembly comprising: a magnetic bead, a hardened layer wrapped around the magnetic bead, and silicone body wrapped around the hardened layer.

21. The magnetic bead assembly according to claim 20, wherein a convex rib is provided at a bottom of the silicone body.

22. The method for stirring milk powder solution according to claim 3, wherein the magnetic bead assembly comprises a magnetic bead, a hardened layer wrapped around the magnetic bead, and silicone body wrapped around the hardened layer.
